(19) United States
(12) Patent Application Publication
(10) Pub. No.: US 2019/0157939 A1
(43) Pub. Date: May 23, 2019

(54) END SHIELD FOR USE IN AN ELECTRIC MACHINE AND METHOD OF FORMING THE SAME

(71) Applicant: REGAL BELOIT AMERICA, INC., Beloit, WI (US)

(72) Inventor: PHILIP A. WILSON, JR., Tipp City, OH (US)

(21) Appl. No.: 15/819,845

(22) Filed: Nov. 21, 2017

(51) Int. Cl. H02K 5/16; H02K 5/22; H02K 7/00; H02K 7/08; H02K 15/14

(52) U.S. Cl. CPC H02K 5/161; H02K 5/22; H02K 5/1732; H02K 7/083; H02K 15/14; H02K 7/003

(57) ABSTRACT

An end shield for an electric machine having a rotational axis includes a plate portion, a circumferential bearing retainer extending axially from the plate portion, and an inner hub coupled to the plate portion and spaced radially inward from the bearing retainer to define a circular groove therebetween. The end shield also includes a pair of boundary walls extending between the bearing retainer and the inner hub across the circular groove such that the pair of boundary walls separate the circular groove into a first chamber and a second chamber. The first chamber is configured to receive a supply of grease therein.

### BACKGROUND

The field of the disclosure relates generally to electric machines, and more specifically, to electric machines that include an end shield with a grease chamber.

At least some known electric machines include an end shield that is positioned proximate a bearing assembly in the assembled electric machine. At least some such end shields include a pocket that holds a lubricant, such as grease, that provides lubrication to the rotating components of the bearing assembly. However, some known end shields include a pocket that forms a complete circle around a shaft such that grease is contained within the entire circumference of the pocket. In such configuration, an excess of grease volume may cause the rotating bearing elements to churn the grease, resulting in energy loss and rising temperatures. This leads to rapid oxidation (chemical degradation) of the grease as well as an accelerated rate of oil bleed, which is a separation of the oil from the thickener. The rising temperatures, along with the oil bleed, may cause the grease to thicken into a hard, crusty build-up that can impair proper lubrication and even block new grease from reaching the core of the bearing. This can result in accelerated wear of the rolling elements of the bearing and a shortened service lifetime of the bearing assembly.

### BRIEF DESCRIPTION

In one aspect, an end shield for an electric machine having a rotational axis is provided. The end shield includes a plate portion, a circumferential bearing retainer extending axially from the plate portion, and an inner hub coupled to the plate portion and spaced radially inward from the bearing retainer to define a circular groove therebetween. The end shield also includes a pair of boundary walls extending between the bearing retainer and the inner hub across the circular groove such that the pair of boundary walls separate the circular groove into a first chamber and a second chamber. The first chamber is configured to receive a supply of grease therein.

In another aspect, an electric machine having a rotational axis is provided. The electric machine includes a shaft configured to rotate about the rotational axis, a bearing assembly coupled to the shaft, and an end shield coupled to the bearing assembly and to the shaft. The end shield includes a plate portion, a circumferential bearing retainer extending axially from the plate portion and coupled to the bearing assembly. The end shield also includes an inner hub extending circumferentially about the shaft and coupled to the plate portion and spaced radially inward from the bearing retainer to define a circular groove therebetween. The end shield also includes a pair of boundary walls extending between the bearing retainer and the inner hub across the circular groove such that the pair of boundary walls separate the circular groove into a first chamber and a second chamber. The first chamber is configured to receive a supply of grease therein:

In yet another aspect, a method for forming an end shield for an electric machine having a rotational axis is provided. The method includes coupling a circumferential bearing retainer to a plate portion such that the bearing retainer extends axially from the plate portion. The method also includes coupling an inner hub to the plate portion such that the inner hub is spaced radially inward from the bearing retainer to define a circular groove therebetween. A pair of boundary walls are formed between the bearing retainer and the inner hub across the circular groove such that the pair of boundary walls separate the circular groove into a first chamber and a second chamber. The first chamber is configured to receive a supply of grease therein.

### BRIEF DESCRIPTION OF THE DRAWINGS

FIG. 1 is a cross-sectional view of an exemplary electric machine.

FIG. 2 is front view of the inside of an exemplary end shield that may be used with the electric machine shown in FIG. 1;

FIG. 3 is an enlarged view of a portion of the end shield shown in FIG. 2;

FIG. 4 is a cross-sectional perspective view of the portion of the end shield taken along line 4-4 shown in FIG. 3; and

FIG. 5 is an enlarged cross-sectional side view of the portion of electric machine 100 bounded by line 5-5 shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION

Described herein is an end shield for an electric machine, wherein the end shield includes a bearing retainer and an inner hub spaced radially inward from the bearing retainer to define a circular groove therebetween. The end shield also includes a pair of boundary walls extending between the bearing retainer and the inner hub across the circular groove such that the pair of boundary walls separate the circular groove into a first chamber configured to receive grease and a second chamber that is intended to remain free from grease. The first chamber extends circumferentially between the boundary walls such that the first chamber defines a volume equal to a predetermined optimum amount of grease for operation of the electric machine. By maintaining the second chamber of the circular groove grease-free, heat transfer from the bearing assembly to the end shield is improved, thereby improving bearing life.

Additionally, the inner hub includes an obliquely oriented radially outer wall that causes the grease to migrate towards the bearing assembly during operation, thus resulting in better oil penetration into the bearing assembly. Furthermore, the end shield described herein causes old, used grease to exit the first chamber through the grease outlet channel when additional grease is added through the grease inlet channel. Such a configuration reduces undesired over-filling of the first chamber during the re-lubrication process.

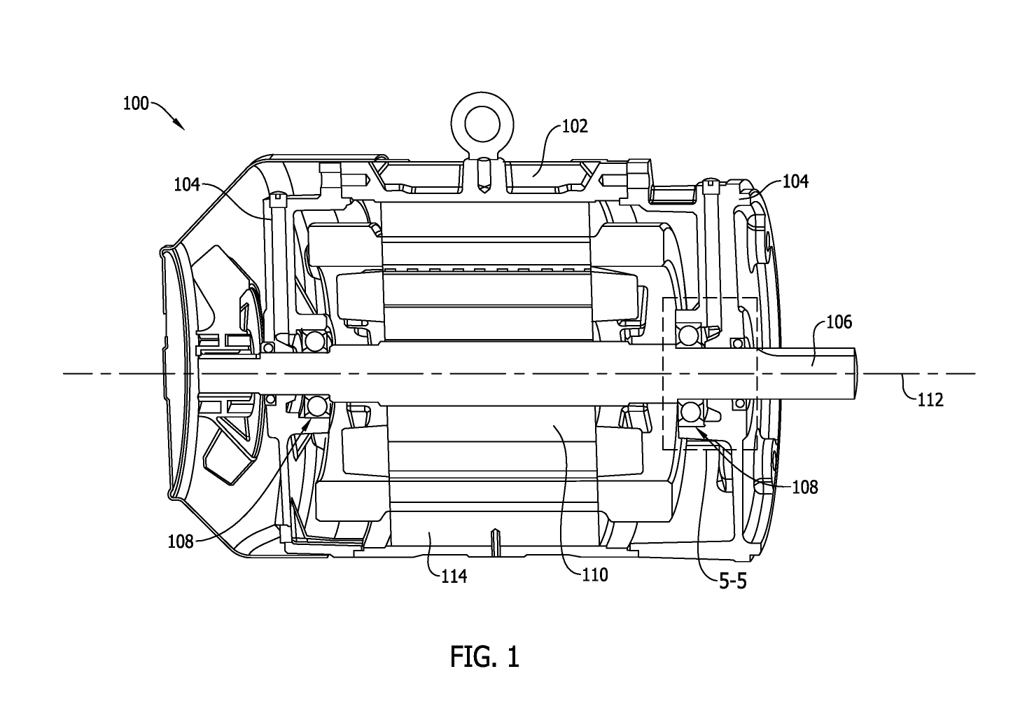

FIG. 1 is a schematic cross-sectional view of an electric machine 100. In the exemplary embodiment, electric machine 100 includes a housing 102 and a pair of end shields 104 coupled at opposing ends of housing 102. A shaft 106 is rotatably supported by a pair of bearing assemblies 108 coupled to a respective one of end shields 104. Shaft 106 supports a rotor 110 of electric machine 100 for rotation about an axis 112. Rotor 110 rotates relative to a stator 114, which is also enclosed within housing 102 between end shields 104.

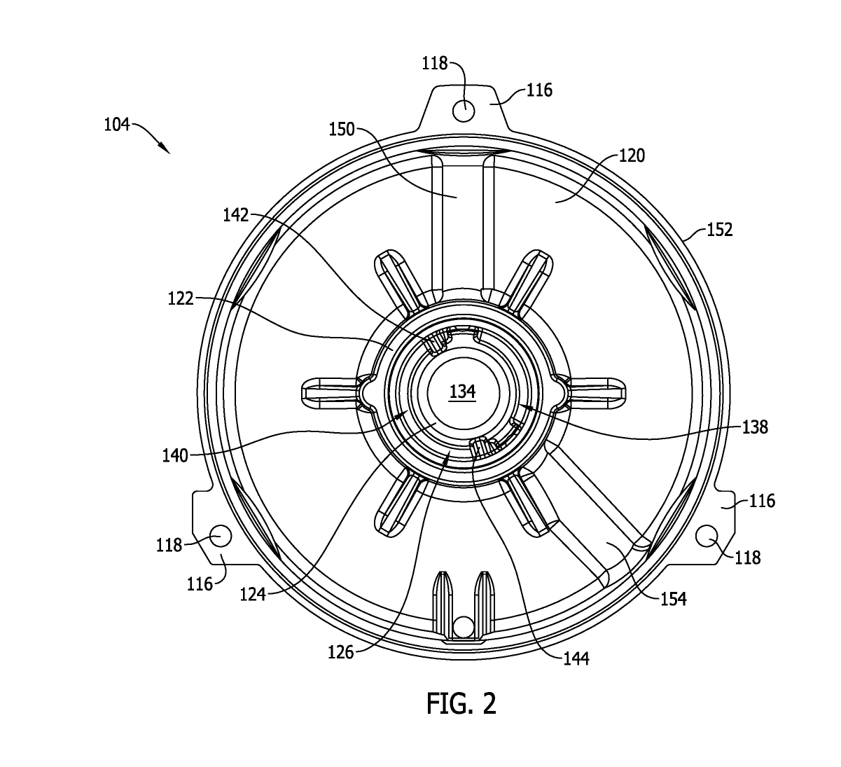

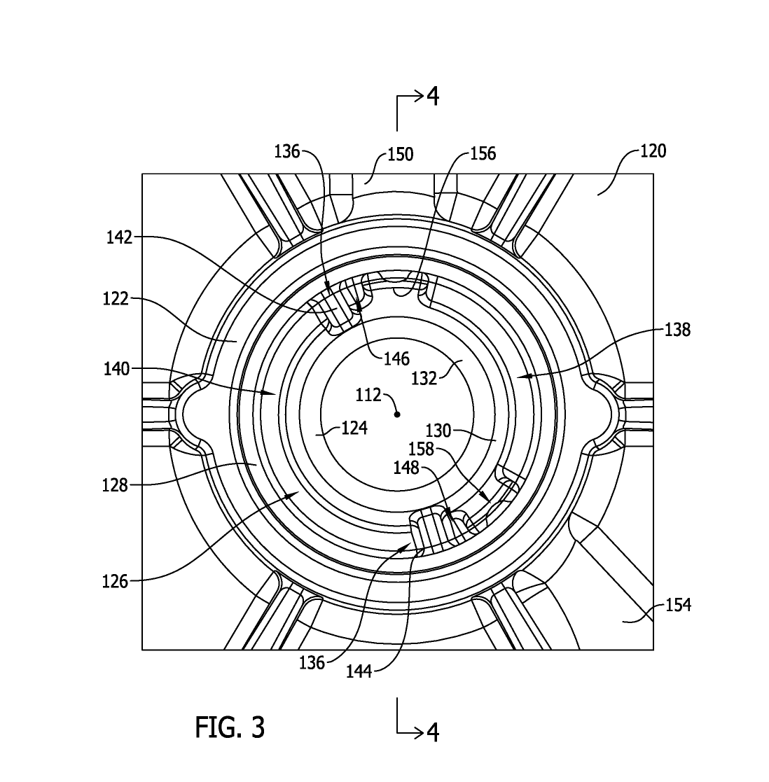

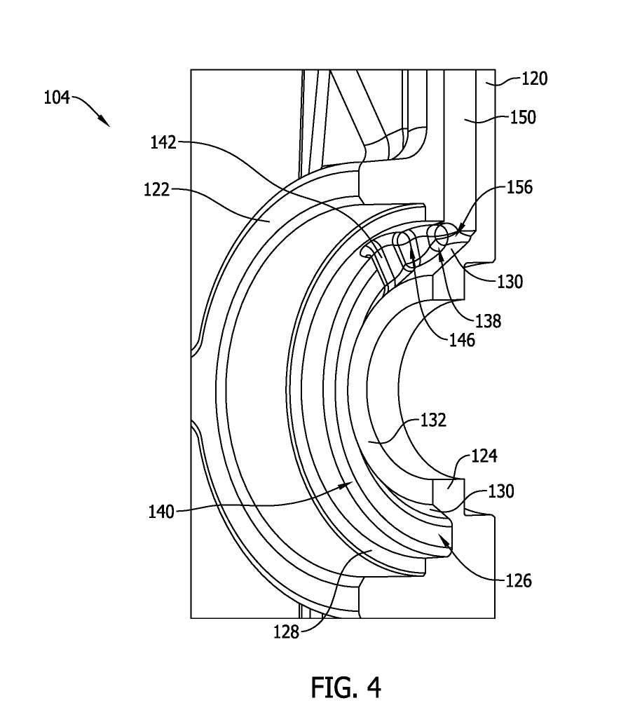

FIG. 2 is front view of the inside of end shield 104 that may be used with electric machine 100 (shown in FIG. 1), FIG. 3 is an enlarged view of a portion of end shield 104, and FIG. 4 is a cross-sectional perspective view of the portion of end shield 104 taken along line 4-4 shown in FIG. 3. In the exemplary embodiment, end shield 104 includes a plurality of mounting flanges 116 that each include a through-hole 118. Mounting flanges 116 and through-holes 118 are provided, for example, to receive assembly bolts (not shown) for coupling end frame 104 to housing 102 or to a load that is also coupled to shaft 106.

In the exemplary embodiment, end shield 104 includes a plate portion 120 and a bearing retainer 122 that extends axially from plate portion 120. Bearing retainer 122 is substantially circular and receives one of bearing assemblies 108 therein. End shield 104 also includes a substantially circular inner hub 124 coupled to plate portion 120 and spaced radially inward from bearing retainer 122 to define a circular groove 126 between bearing retainer 122 and inner hub 124. More specifically, bearing retainer 122 includes a circular shoulder 128 (shown in FIG. 3) that extends radially inward towards inner hub 124 such that groove 126 is defined between shoulder 128 of bearing retainer 122 and inner hub 124.

As best shown in FIG. 4, inner hub 124 includes a radially outer wall 130 (shown in FIG. 4) that at least partially defines groove 126 and an end face 132 (shown in FIG. 4) coupled to radially outer wall 130 and at least partially defining a central shaft bore 134 (shown in FIG. 3) through which shaft 106 (shown in FIG. 1) extends when electric machine 100 is assembled. Radially outer wall 130 is obliquely oriented with respect to axis 112 to facilitate grease flow to bearing assembly 108, as described in further detail below. End face 132 is oriented perpendicular to axis 112 and extends radially inward from radially outer wall 130.

In the exemplary embodiment, end shield 104 includes a pair of boundary walls 136 extending between bearing retainer 122 and inner hub 124 across groove 126 such that boundary walls 130 divide or separate groove 126 into a first chamber 138 and a second chamber 140. Boundary walls 130, plate portion 120, bearing retainer 122, and inner hub 124 are integrally formed together such that end shield 104 is a monolithic component.

Boundary walls 130 include a first wall 142 and a second wall 144 that each extend between radially outer wall 130 of inner hub 124 and shoulder 128 of bearing retainer 122. Similarly, groove 126 extends between radially outer wall 130 of inner hub 124 and shoulder 128 of bearing retainer 122 such that walls 142 and 144 extend across the full radial width of groove 126. In the exemplary embodiment, end shield 104 includes only walls 142 and 144 such that groove 126 is divided into only first chamber 138 and second 140. As such, first and second chambers 138 and 140 combine to extend a complete circumference of groove 126.

In the exemplary embodiment, first chamber 138 is configured to receive a supply of grease, and second chamber 140 is configured to remain vacant and free of grease. More specifically, first wall 142 defines a first end 146 of first chamber 138 and second wall 144 defines a second end 148 of first chamber 138 such that first chamber 138 extends circumferentially between first wall 142 and second wall 144. In the exemplary embodiment, first chamber 138 extends circumferentially about a portion of the circumference of groove 126 such that first chamber 138 defines a volume that is configured to contain an optimum amount of grease for electric machine 100. Specifically, first chamber 138 extends within a range of approximately 50% to approximately 66% about the circumference of groove 126. More specifically, first chamber 138 extends within a range of approximately 55% to approximately 62% about the circumference of groove 126. Generally, first chamber 138 extends an amount about the circumference of groove 126 to enable an optimum amount of grease to be contained in first chamber 138.

As best shown in FIG. 2, plate portion 120 includes a grease inlet channel 150 defined therethrough and extending radially between a radially outer edge 152 of plate portion 120 and first chamber 138. Similarly, plate portion 120 includes a grease outlet channel 154 defined therethrough and extending radially between radially outer edge 152 of plate portion 120 and first chamber 138. In the exemplary embodiment, outlet channel 154 is oriented within a range of approximately 110 degrees to approximately 180 degrees from inlet channel 150 about plate portion 120. Alternatively, outlet channel 154 is oriented at any angle from inlet channel 150 to facilitate operation of end shield 104 as described herein. Additionally, in one embodiment, inlet channel 150 is oriented perpendicular to axis 112. Alternatively, inlet channel 150 is oriented at any angle with respect to axis 112 to facilitate operation of end shield 104 as described herein.

In the exemplary embodiment, inlet channel 150 is coupled in flow communication with first chamber 138 through a grease inlet 156 formed adjacent first wall 142 at first end 146 of first chamber 138. Similarly, outlet channel 154 is coupled in flow communication with first chamber 138 through a grease outlet 158 formed adjacent second wall 144 at second end 148 of first chamber 138. In such a configuration, grease inlet 156 and grease outlet 158 are both positioned between first and second walls 142 and 144 within first chamber 138. As such, grease flowing into first chamber 138 through grease inlet 156 from inlet channel 150 is not impeded as it flows circumferentially through first chamber 138 toward grease outlet 158 and, in re-lubrication operation, forces old grease through grease outlet 158 into outlet channel 154 and out of end shield 104.

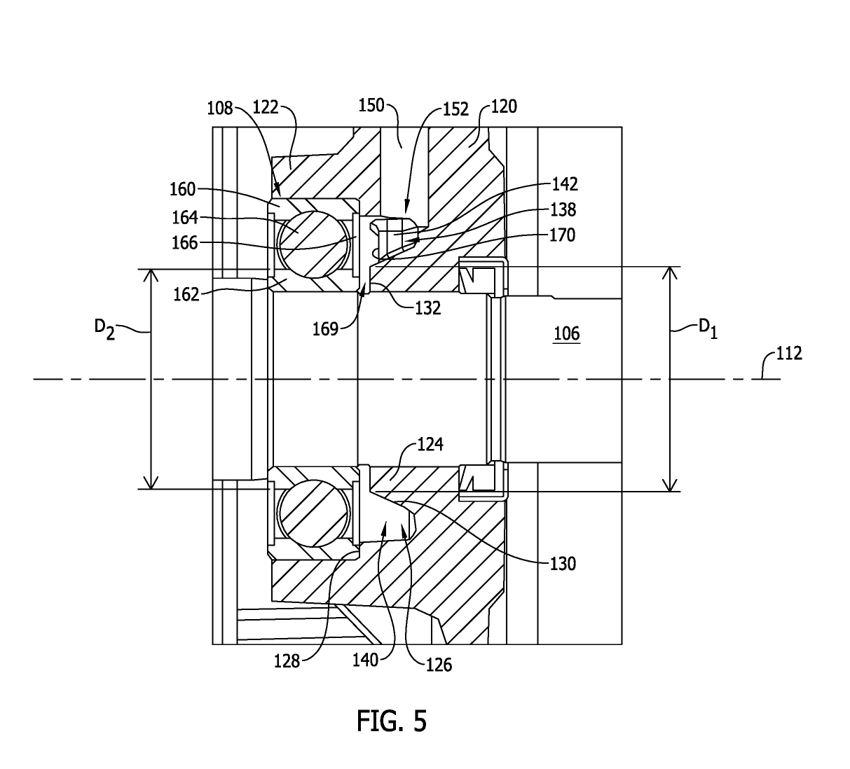

FIG. 5 is an enlarged cross-sectional side view of the portion of electric machine 100 bounded by line 5-5 (shown in FIG. 1). In the exemplary embodiment, bearing assembly 108 includes an outer race 160, an inner race 162, a plurality of bearings 164 positioned therebetween, and a pair of shields 166 coupled between inner race 162 and outer race 160 to prevent foreign object debris from entering bearing assembly 108. As shown FIG. 5, end face 132 of inner hub 124 defines a first outer diameter D1 and inner race 162 of bearing assembly 108 defines a second outer diameter D2 that is smaller than first outer diameter D1. As described herein, smaller second outer diameter D2 facilitates channeling grease in a gap 169 between end face 132 and inner race 162 into bearing assembly 108 rather than back into first chamber 138.

In one embodiment, first wall 142 includes an end face 170 that is axially offset from end face 132 of inner hub 124 such that first wall 142 does not extend to a full height of groove 126. In another embodiment, end face 170 of first wall 142 is aligned with end face 132 of inner hub 124 to inhibit grease from entering second chamber 140.

In operation, grease is pumped into end shield 104 and flows through inlet channel 150 before entering first chamber 138 via grease inlet 152. As more grease is pumped into end shield 104, first wall 142 inhibits the grease from flowing into second chamber 140 and directs the grease circumferentially into first chamber 138. The grease is channeled around inner hub 124 through first chamber 138 until first chamber 138 is filled with an optimum amount of grease, at which point any additional grease pumped into end shield 104 will cause excess grease to be channeled out of first chamber 138 via grease outlet 158 and through outlet channel 154. As such, first chamber 138 is sized to contain a predetermined optimum amount of grease to keep bearing assembly 108 lubricated without providing an excess amount of grease. During re-lubrication, new grease is pumped into end shield 104 and forces the old grease around first chamber 138 and out of end shield 104 via outlet channel 154.

During operation of electric machine 100, the oblique orientation of radially outer surface 130 of inner hub 124 facilitates channeling the grease towards bearing assembly 108. Gap 169 between end face 132 and inner race 162 receives a portion of the grease in first chamber 138 and allows grease and the oil from the grease to flow into bearing assembly 108 before flowing back into first chamber 138, due to end face 132 having a large diameter D1 than inner race D2.

The apparatus and method herein describe an end shield for an electric machine, wherein the end shield includes a bearing retainer and an inner hub spaced radially inward from the bearing retainer to define a circular groove therebetween. The end shield also includes a pair of boundary walls extending between the bearing retainer and the inner hub across the circular groove such that the pair of boundary walls separate the circular groove into a first chamber configured to receive grease and a second chamber that is intended to remain free from grease. The first chamber extends circumferentially between the boundary walls such that the first chamber defines a volume equal to a predetermined optimum amount of grease for operation of the electric machine. By maintaining the second chamber of the circular groove grease-free, heat transfer from the bearing assembly to the end shield is improved, thereby improving bearing life.

Additionally, the obliquely oriented radially outer wall of the inner hub causes the grease to migrate towards the bearing assembly during operation, thus resulting in better oil penetration into the bearing assembly. Furthermore, the end shield described herein causes old, used grease to exit the first chamber through the grease outlet channel when additional grease is added through the grease inlet channel. Such a configuration reduces undesired over-filling of the first chamber during the re-lubrication process.

Exemplary embodiments of an electric machine are described above in detail. The electric machine and its components are not limited to the specific embodiments described herein, but rather, components of the systems may be utilized independently and separately from other components described herein. For example, the end shield may also be used in combination with other electric machines and is not limited to practice with only the electric machine as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An end shield for an electric machine having a rotational axis, said end shield comprising:
a plate portion;
a circumferential bearing retainer extending axially from said plate portion;
an inner hub coupled to said plate portion and spaced radially inward from said bearing retainer to define a circular groove therebetween;
a pair of boundary walls extending between said bearing retainer and said inner hub across said circular groove such that said pair of boundary walls separate said circular groove into a first chamber and a second chamber, wherein said first chamber is configured to receive a supply of grease.

2. The end shield in accordance with claim 1, wherein said pair of boundary walls comprises a first wall that defines a first end of said first chamber and a second wall that defines a second end of said first chamber.

3. The end shield in accordance with claim 2, further comprising a grease inlet positioned adjacent said first wall and a grease outlet positioned adjacent said second wall, wherein said grease inlet and said grease outlet are positioned between said first wall and said second wall and within said first chamber.

4. The end shield in accordance with claim 3, wherein said plate portion comprises:
a grease inlet channel defined radially therethrough and coupled in flow communication with said first chamber through said grease inlet; and
a grease outlet channel defined radially therethrough and coupled in flow communication with said first chamber through said grease outlet.

5. The end shield in accordance with claim 1, wherein said plate portion, said bearing retainer, said inner hub, and said pair of boundary walls are integrally formed as a monolithic component.

6. The end shield in accordance with claim 1, wherein said first chamber extends within a range of approximately 50% to 66% about a circumference of said circular groove.

7. The end shield in accordance with claim 1, wherein said bearing retainer comprises a shoulder, and wherein said pair of boundary walls extend between said shoulder and a radially outer wall of said inner hub.

8. The end shield in accordance with claim 7, wherein said radially outer wall of said inner hub is obliquely oriented with respect to the rotational axis.

9. The end shield in accordance with claim 1, wherein said inner hub comprises a first end face and wherein said pair of boundary walls each comprise a second end face that is axially offset with respect to said first end face.

10. An electric machine having a rotational axis, said electric machine comprising:
a shaft configured to rotate about the rotational axis;
a bearing assembly coupled to said shaft; and
an end shield coupled to said bearing assembly and to said shaft, said end shield comprising:
a plate portion;
a circumferential bearing retainer extending axially from said plate portion and coupled to said bearing assembly;
an inner hub coupled to said plate portion and spaced radially inward from said bearing retainer to define a circular groove therebetween, wherein said inner hub extends circumferentially about said shaft;
a pair of boundary walls extending between said bearing retainer and said inner hub across said circular groove such that said pair of boundary walls separate said circular groove into a first chamber and a second chamber, wherein said first chamber is configured to receive a supply of grease.

11. The electric machine in accordance with claim 10, wherein said pair of boundary walls comprises a first wall that defines a first end of said first chamber and a second wall that defines a second end of said first chamber.

12. The electric machine in accordance with claim 11, further comprising a grease inlet positioned adjacent said first wall and a grease outlet positioned adjacent said second wall, wherein said grease inlet and said grease outlet are positioned between said first wall and said second wall and within said first chamber.

13. The electric machine in accordance with claim 12, wherein said plate portion comprises:
a grease inlet channel defined radially therethrough and coupled in flow communication with said first chamber through said grease inlet; and
a grease outlet channel defined radially therethrough and coupled in flow communication with said first chamber through said grease outlet.

14. The electric machine in accordance with claim 10, wherein said plate portion, said bearing retainer, said inner hub, and said pair of boundary walls are integrally formed as a monolithic component.

15. The electric machine in accordance with claim 10, wherein said inner hub comprises a first end face that defines a first outer diameter, and wherein said bearing assembly comprises an inner race that defines a second outer diameter, wherein said second outer diameter is smaller than said first outer diameter of said first end face.

16. The electric machine in accordance with claim 10, wherein said pair of boundary walls each comprise a second end face that is axially aligned with respect to said first end face of said inner hub.

17. A method for forming an end shield for an electric machine having a rotational axis, said method comprising:
coupling a circumferential bearing retainer to a plate portion such that the bearing retainer extends axially from the plate portion;
coupling an inner hub to the plate portion such that the inner hub is spaced radially inward from the bearing retainer to define a circular groove therebetween;
forming a pair of boundary walls between the bearing retainer and the inner hub across the circular groove such that the pair of boundary walls separate the circular groove into a first chamber and a second chamber, wherein the first chamber is configured to receive a supply of grease.

18. The method in accordance with claim 17, wherein forming the pair of boundary walls comprises:
forming a first wall that defines a first end of the first chamber; and
forming a second wall that defines a second end of the first chamber;
wherein said method further comprises:
forming a grease inlet adjacent the first wall; and
forming a grease outlet adjacent the second wall, wherein the grease inlet and the grease outlet are formed between the first wall and the second wall and within the first chamber.

19. The method in accordance with claim 17, further comprising integrally forming the plate portion, the bearing retainer, the inner hub and the pair of boundary walls as a monolithic component.

20. The method in accordance with claim 17, wherein forming the pair of boundary walls to define the first chamber and the second chamber comprises forming the pair of boundary walls such that the first chamber and the second chamber combine to extend an entire circumference of the circular groove.
